(19) United States
(12) Patent Application Publication
(10) Pub. No.: US 2026/0336807 A1
(43) Pub. Date: Oct. 29, 2026

(54) PASSENGER SEAT DEVICE

(71) Applicant: RECARO Aircraft Seating GmbH & Co. KG, Schwaebisch Hall (DE)

(72) Inventors: Andreas ERB, Auenwald (DE); Michael HORLACHER, Schwäbisch Hall (DE); Bernd SOMMER, Schwäbisch Hall (DE)

(21) Appl. No.: 19/107,434

(22) PCT Filed: Sep. 1, 2023
(86) PCT No.: PCT/EP2023/074018

§ 371 Date: Feb. 27, 2025

(30) Foreign Application Priority Data
Sep. 2, 2022 (DE) 10 2022 122 322.1

(51) Int. Cl. B64D 11/06; B61D 33/00

(52) U.S. Cl. CPC B64D 11/064; B64D 11/0696; B61D 33/0021

(57) ABSTRACT

A passenger seat device has a mounting unit which is configured for mounting on a cabin floor, further has a backrest, and has a bearing device which is configured to support the backrest pivotably relative to the mounting unit between an upright sitting position and a comfort position, wherein the backrest comprises a pivotable backrest element, wherein the passenger seat device has at least one restoring module which is configured at least to provide a restoring force for restoring the backrest from the comfort position into the upright sitting position, and for this purpose comprises at least one leaf spring element.

### CROSS-REFERENCE TO RELATED APPLICATIONS

This application is a U.S. national stage application of international patent application PCT/EP2023/074018, filed on Sep. 1, 2023, which is based on and claims priority to German patent application DE 10 2022 122 322.1, filed on Sep. 2, 2022, the contents of which are incorporated herein by reference.

### PRIOR ART

The invention relates to a passenger seat device.

A passenger seat device having a mounting unit which is configured for mounting on a cabin floor, having a backrest, and having a bearing device which is configured to support the backrest pivotably relative to the mounting unit between an upright sitting position and a comfort position, wherein the backrest comprises a pivotable backrest element, has already been proposed.

The objective of the invention is in particular to provide a generic device having improved properties with regard to compactness and advantageously great leg freedom for a passenger. The objective is achieved according to the invention.

### ADVANTAGES OF THE INVENTION

The invention is based on a passenger seat device having a mounting unit which is configured for mounting on a cabin floor, having a backrest, and having a bearing device which is configured to support the backrest pivotably relative to the mounting unit between an upright sitting position and a comfort position, wherein the backrest comprises a pivotable backrest element.

It is proposed that the passenger seat device has at least one restoring module which is configured at least to provide a restoring force for restoring the backrest from the comfort position into the upright sitting position, and for this purpose comprises at least one leaf spring element. A “passenger seat device” is preferably to be understood as a device which forms at least a part of a passenger seat and/or the entire passenger seat. The passenger seat device is preferably embodied as an aircraft seat device. A “passenger seat” is preferably to be understood in particular as a seat which is configured to form a seat region for a passenger and for this purpose is arranged in a means of transport. The passenger seat is preferably embodied as an aircraft seat. In principle, it is also conceivable for the passenger seat to be embodied as a train seat. In principle, it would also be conceivable for the passenger seat to be embodied as a seat for another means of transport. The passenger seat is preferably embodied as part of a seat row of a plurality of passenger seats arranged next to one another. The passenger seat preferably comprises at least one seat bottom which forms a seat region for a passenger, and a backrest which provides a backrest contact surface against which a passenger sitting on the passenger seat can rest his/her back. A “seat bottom” is in this case to be understood in particular as a part of the passenger seat which provides a seat region on which a passenger can sit, wherein the seat bottom in this case preferably has at least one main body and an upholstery element arranged on the main body. Furthermore, the passenger seat has a mounting unit by means of which the passenger seat is mounted on a floor, in particular a cabin floor, and to which further components of the passenger seat, such as the seat bottom and the backrest, are attached. A “mounting unit” is preferably to be understood as a basic structure of the passenger seat which forms a load-bearing structure of the passenger seat. The passenger seat is attached to a mounting plane, that is to say in particular the cabin floor, by means of the mounting unit. The mounting unit preferably has at least two seat feet and at least one transverse element which is coupled to the seat feet. The transverse element forms a support tube. The mounting unit preferably has two transverse elements, a front transverse element and a rear transverse element. The mounting unit is preferably coupled to the floor, preferably to corresponding fastening rails in the floor, by means of a plurality of fittings. The mounting unit forms a load-bearing frame of the passenger seat, preferably of the entire passenger seat row.

A “bearing device” is intended to be understood to mean a module by means of which the backrest, in particular a pivotable backrest element of the backrest, is pivotably supported on a unit, such as in particular the mounting unit. The bearing device can preferably be formed by a bearing bolt. In principle, it is likewise conceivable for the bearing device to be formed by a hinge or another bearing mechanism by means of which the backrest, in particular the pivotable backrest element, is pivotably supported. The bearing device forms an axis of rotation about which the backrest, in particular the pivotable backrest element, is pivotable. The fact that the backrest is pivotable is intended to be understood to mean that at least the pivotable backrest element of the backrest is pivotable relative to a mounting structure, that is to say the mounting unit. A “pivotable backrest element” is preferably intended to be understood to mean a backrest element which forms at least a part, preferably a large part, of the backrest surface of the backrest and which is pivotably supported relative to the mounting unit in order to form the comfort position and the upright sitting position. The pivotable backrest element is pivotably supported relative to the mounting unit in order to form the comfort position and the upright sitting position. The pivotable backrest element has a load-bearing basic structure and forms the backrest surface in its inner region. The pivotable backrest element preferably has a backrest frame and a fabric or shell element which is connected to the backrest frame and forms the backrest surface. In principle, it would also be conceivable for the pivotable backrest element to be formed by a sandwich component. In this case, it would be conceivable for the pivotable backrest element not to have a backrest frame.

The pivotable backrest element is preferably pivotably attached to the mounting unit of the passenger seat. The pivotable backrest element is preferably attached to seat structure elements of the passenger seat. A “seat structure element” is preferably to be understood as a part of a load-bearing structure of the passenger seat, to which further components of the passenger seat, such as, for example, a backrest, a backrest element or an armrest, can be fastened. A seat structure element is preferably embodied as a seat divider. The seat structure element embodied as a seat divider is preferably rigidly connected to the at least one, preferably to the two transverse elements of the mounting unit. The seat structure element embodied as a seat divider preferably extends substantially horizontally from the front transverse element into a region behind the rear transverse element. In a region behind the rear transverse element, the seat structure element embodied as a seat divider extends away from the mounting plane in a substantially vertical direction, preferably into an armrest height. In principle, it is also conceivable for the seat structure elements to be embodied in one piece with a part of a seat shell, for example with a lower backrest element. In this case, the seat structure elements embodied in one piece could be embodied, for example, by side regions of a seat shell.

The seat structure elements preferably each have a bearing point for supporting the backrest, in particular the pivotable backrest element. A “bearing point” is preferably to be understood as an attachment point via which a component, such as, for example, a backrest element, can be fixedly attached. A component can preferably be attached both rigidly and movably via a bearing point. The bearing point is preferably configured to attach a further component, such as, in particular, a backrest element, movably, preferably pivotably, to the component forming the bearing point. A bearing element, in particular a bearing bolt of the bearing device for supporting the pivotable backrest element, is preferably attached to a bearing point.

An “upright sitting position” is to be understood as a maximum upright sitting position of the passenger seat in which the passenger seat has a maximum upright sitting position. If the passenger seat is embodied as an aircraft seat, the upright sitting position is preferably embodied as a sitting position which has to be assumed for safety reasons, in particular in a starting phase, in a landing phase and during turbulence. The upright sitting position is in this case embodied as a so-called TTL position (taxi, takeoff, landing). In the upright sitting position, the backrest, in particular a movably supported backrest element, and the seat bottom of the passenger seat are substantially perpendicular to one another, preferably at an angle of between 95 degrees and 115 degrees. A “comfort position” is to be understood in particular as a rearwardly inclined sitting position of the passenger seat in which at least the backrest, in particular a pivotable backrest element, is inclined rearwardly counter to a sitting direction of the passenger seat, as a result of which a passenger sitting on the passenger seat is enabled to have a comfortable, rearwardly inclined sitting position. In principle, it is also conceivable for the seat bottom to also be inclined in the comfort position in addition to the pivotable backrest element, in contrast to the upright sitting position of the passenger seat. In the comfort position, the backrest, in particular the pivotable backrest element, and the seat bottom can in particular have a different, in particular advantageously greater, angle to one another than in the upright sitting position (TTL position). In the comfort position, the backrest, in particular the pivotable backrest element, is pivoted rearwardly from a maximum upright sitting position by at least 3 degrees, preferably at least 5 degrees, particularly preferably by more than 8 degrees.

A “restoring module” is preferably intended to be understood to mean a module which is configured to exert a restoring force for restoring the backrest, in particular a movably supported backrest element, in order to move said backrest element from a position, in particular a comfort position, into an upright sitting position. For this purpose, the restoring module preferably has an element which provides a force for adjusting the backrest, in particular the pivotable backrest element. The element for providing a restoring force is formed as a leaf spring element. The restoring module has a locking unit which is configured to lock or unlock the restoring module itself and/or the pivotable backrest element. The locking unit has a locked state and an unlocked state. In its locked state, the locking unit locks the restoring module and/or the pivotable backrest element and the restoring module cannot exert a restoring force on the pivotable backrest element. In its unlocked state, the restoring module is unlocked by the locking unit and can exert a restoring force on the backrest, in particular the pivotable backrest element, in order to adjust the backrest into its upright sitting position. The locking unit preferably has at least one locking element which mechanically locks the restoring module itself and/or the pivotable backrest element. The locking element is preferably embodied as a form-fitting and/or force-fitting element. The locking element is adjustable between a locked position and an unlocked position. The locking element is preferably adjustable between its locked position and its unlocked position by means of a mechanical adjusting element, such as, for example, a Bowden cable. In principle, it is also conceivable for the locking element to be adjustable between its locked position and its unlocked position by means of an electric actuator, for example an electromagnetic actuator. For example, it would also be conceivable for the locking element to be embodied as a part of an electronic actuator, in particular an electromechanical actuator. It is thus conceivable for the restoring module and/or the pivotable backrest element to be lockable or unlockable electrically or electronically by means of the locking unit. A “leaf spring element” is preferably intended to be understood to mean an elongate spring element which is configured to provide, in a tensioned state, a spring force which is configured substantially orthogonally with respect to a main direction of extent of the leaf spring element. “Configured” is intended to be understood in particular as specifically designed and/or equipped. The fact that an object is configured for a specific function is intended to be understood in particular to mean that the object performs and/or carries out this specific function in at least one use state and/or operating state.

The passenger seat is configured as a seat with a purely mechanical adjustment. In particular, an adjustment of the backrest, in particular of the pivotable backrest element, is effected merely by an adjustment force applied by a passenger and/or the force of a spring element. The passenger seat preferably has no electromechanical actuators by means of which an electric adjustment of the passenger seat, in particular an electric adjustment of the passenger seat, in particular of a backrest and/or of a seat bottom, between an upright sitting position and a comfort position is possible. The passenger seat is preferably not embodied as a business-class or first-class seat which has an electronic passenger seat adjustment.

By means of an implementation according to the invention, it is advantageously possible to provide a particularly compact passenger seat device in which a restoring module is embodied in a particularly advantageous manner. Particularly advantageously, by means of the implementation according to the invention, it is possible to provide a passenger seat which provides a particularly advantageous leg freedom for a passenger, in particular a passenger sitting behind the passenger seat, since the restoring module can be embodied in a particularly space-saving manner. As a result, a passenger seat, in particular in a knee region, can be embodied in a particularly narrow manner and can have a particularly advantageously great leg freedom.

Furthermore, it is proposed that the pivotable backrest element is pivotably connected to the mounting unit via the bearing device, wherein the leaf spring element is functionally arranged between the pivotable backrest element and the mounting unit. “Functionally arranged between two elements” is preferably intended to be understood to mean that the leaf spring element rests with one side directly or indirectly against the mounting unit and with a second side directly or indirectly against the pivotable backrest element and is thereby configured to allow a spring force to act between the mounting unit and the pivotable backrest element. The leaf spring element is attached with a first end to the pivotable backrest element. The leaf spring element is attached with a second end to the mounting unit. “Attached” is preferably to be understood as optionally fixedly connected or abutting. The leaf spring element can preferably be connected directly or indirectly to the pivotable backrest element or the mounting unit. The restoring module preferably has a first fastening unit for attaching the leaf spring element to the pivotable backrest element. The restoring module preferably has a second fastening unit for attaching the leaf spring element to the mounting unit. The first fastening unit or the second fastening unit is preferably optionally embodied as a floating bearing via which the leaf spring element can carry out a relative movement to the pivotable backrest element or the mounting unit at least in one direction. In principle, it is also conceivable for both fastening units to be embodied as a floating bearing. As a result, the backrest can be embodied in a particularly advantageous manner.

Furthermore, it is proposed that the leaf spring element is at least partially integrated into the pivotable backrest element. “At least partially integrated” is preferably to be understood to mean that the leaf spring element is rigidly connected to at least one partial region of the pivotable backrest element. In this case, the leaf spring element can merely be connected to the pivotable backrest element, or else can also form a part of a load-bearing structure of the pivotable backrest element. As a result, the leaf spring element can be installed in a particularly advantageous and space-saving manner.

Furthermore, it is proposed that the leaf spring element is at least partially formed in one piece with the pivotable backrest element. “In one piece” is intended to be understood in particular as at least cohesively connected, for example by a welding process, an adhesive bonding process, an injection-molding process and/or another process which appears expedient to the person skilled in the art, and/or advantageously formed in one piece, such as, for example, by production from a casting and/or by production in a single-component or multi-component injection-molding method and advantageously from a single blank. The fact that the leaf spring element is at least partially formed in one piece is preferably intended to be understood to mean that at least one partial region of the leaf spring element is formed by the pivotable backrest element. As a result, the leaf spring element can be integrated into the passenger seat device in a particularly simple and space-saving manner.

Furthermore, it is proposed that the backrest has at least in a lower region elastic ribs which each extend laterally outwards from a central region and which are configured for being deflected in a spring-elastic manner. The elastic ribs are preferably formed as part of the pivotable backrest element of the backrest. In this case, the ribs are preferably at least partially formed in one piece with the pivotable backrest element. In principle, it would also be conceivable for the rib elements to be formed in each case as separate elements which are mounted in an exchangeable manner on a main body of the pivotable backrest element. In principle, it is also conceivable for the ribs to be formed by a rigid lower backrest element. Furthermore, it is likewise conceivable for the elastic ribs to be formed as part of a separate component connected to the backrest, in particular a shell element. In this case, the elastic ribs can optionally be embodied as integrated, one-piece elements with the respective component or as elements which can be mounted in an exchangeable manner. As a result, the backrest can be embodied in a particularly lightweight and comfortable manner.

Furthermore, it is proposed that the pivotable backrest element comprises a shell element which substantially forms in one piece a vertically continuous central region and the laterally outwardly extending ribs in a lower region. A “shell element” is preferably intended to be understood to mean a planar element composed of a fiber-reinforced plastic. The outwardly extending ribs are preferably formed completely in one piece by the shell element. In principle, it is also conceivable for at least one partial region of the outwardly extending ribs to be formed separately and to be connected to the shell element in a mounting step. As a result, the pivotable backrest element can be embodied in a particularly advantageous manner.

Furthermore, it is proposed that the continuous central region of the shell element has a receiving region for the leaf spring element or at least partially forms the leaf spring element. A “receiving region” is preferably intended to be understood to mean a region which forms a receptacle for an element, such as in particular the leaf spring element, in which the leaf spring element is attached in a force-fitting, integrally bonded and/or form-fitting manner. As a result, the leaf spring element can be integrated into the pivotable backrest element in an advantageously simple manner.

Furthermore, it is proposed that the backrest comprises a lower, rigid backrest element, wherein the leaf spring element is functionally arranged between the lower backrest element and the pivotable backrest element. A “lower backrest element” is preferably intended to be understood to mean an element which rigidly forms a lower part of the backrest which faces a seat bottom. The lower backrest element is preferably formed by a shell element. The lower backrest element is preferably formed by a shell element composed of a fiber-reinforced plastic. The lower backrest element is preferably formed as a separate element. The lower backrest element is preferably fastened rigidly, that is to say immovably, to the mounting unit. In principle, it is likewise conceivable for the lower backrest element to be embodied in one piece with a seat shell of the seat bottom. As a result, the backrest can be provided in a particularly advantageous manner with a high pivot point, as a result of which, in particular, a backrest which is advantageously narrow in the knee region can be provided.

Furthermore, it is proposed that the leaf spring element is at least partially formed in one piece with the lower backrest element for providing a restoring force. As a result, the leaf spring element can be embodied in an advantageously simple manner and can be integrated into the passenger seat.

Furthermore, it is proposed that the bearing device forms an axis of rotation via which the pivotable backrest element is pivotably supported relative to the lower backrest element, wherein the axis of rotation is arranged above a knee region of the backrest. A “knee region” is preferably to be understood as a region of the backrest in which the knees of a passenger sitting behind the passenger seat are arranged. The knee region is preferably embodied as a region which extends from a lower end of the backrest into a region of at least 650 mm, particularly preferably of 700 mm, above the mounting plane. The knee region is preferably embodied as a region of the backrest between 400 mm and 700 mm, particularly preferably as a region of the backrest between 450 mm and 650 mm, measured from the mounting plane. As a result, a particularly advantageous knee region for a passenger sitting behind the passenger seat can be provided.

The passenger seat device according to the invention is not intended to be restricted here to the application and embodiment described above. In particular, the passenger seat device according to the invention can have a number of individual elements, components and units differing from a number mentioned herein in order to fulfill a functionality described herein.

### DRAWINGS

Further advantages result from the following description of the drawings. The drawings show six exemplary embodiments of the invention. The drawings, the description and the claims contain numerous features in combination. The person skilled in the art will expediently also consider the features individually and combine them to form expedient further combinations. In the drawings:

FIG. 1 shows a schematic view of a passenger seat row with a passenger seat device in a first exemplary embodiment with a backrest with an upper backrest pivot point and a restoring module with a leaf spring element,

FIG. 2 shows a schematic rear view of the passenger seat row with the restoring module and the leaf spring element,

FIG. 3 shows a schematic side view with two passenger seat rows and a pivotable backrest element in an upright sitting position and a comfort position,

FIG. 4 shows a detailed view of an attachment of the leaf spring element by means of a fastening unit,

FIG. 5 shows a schematic view of a passenger seat row with a passenger seat device in a second exemplary embodiment with a backrest with an upper backrest pivot point, which has a fabric, and a restoring module with a leaf spring element,

FIG. 6 shows a schematic rear view of the passenger seat with the fabric-covered backrest element, which has a fabric, and the restoring module with the leaf spring element,

FIG. 7 shows a schematic illustration of a pivotable backrest element, which forms a spring element embodied as a leaf spring element, in a third exemplary embodiment of the passenger seat device,

FIG. 8 shows a schematic illustration of a passenger seat device in a fourth exemplary embodiment with a restoring module with a leaf spring element, which is formed by a lower backrest element,

FIG. 9 shows a schematic illustration of a passenger seat device in a fifth exemplary embodiment, with a pivotable backrest with a lower backrest pivot point, and with a restoring module which has a leaf spring element, and

FIG. 10 shows a schematic illustration of a passenger seat device in a sixth exemplary embodiment, with a seat shell element, which forms a seat bottom and a lower backrest element, and with a restoring module which has a leaf spring element.

### DESCRIPTION OF THE EXEMPLARY EMBODIMENTS

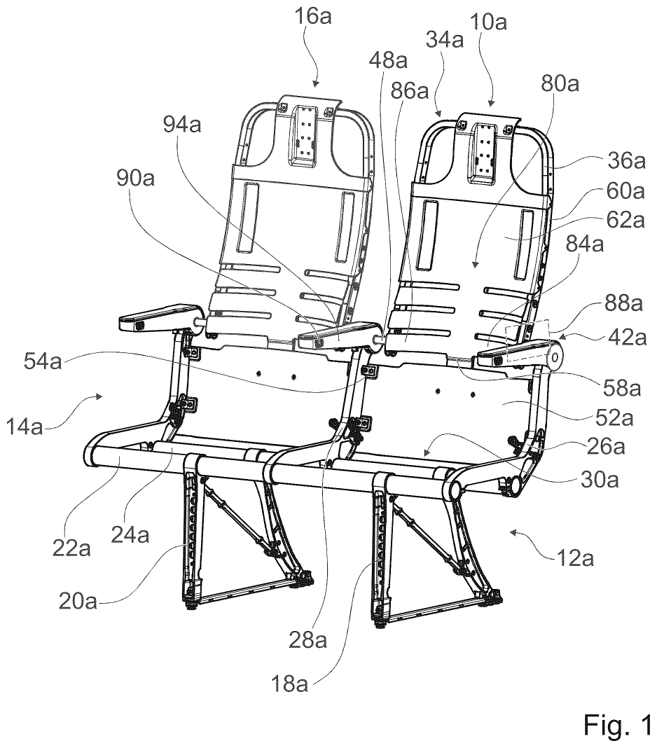

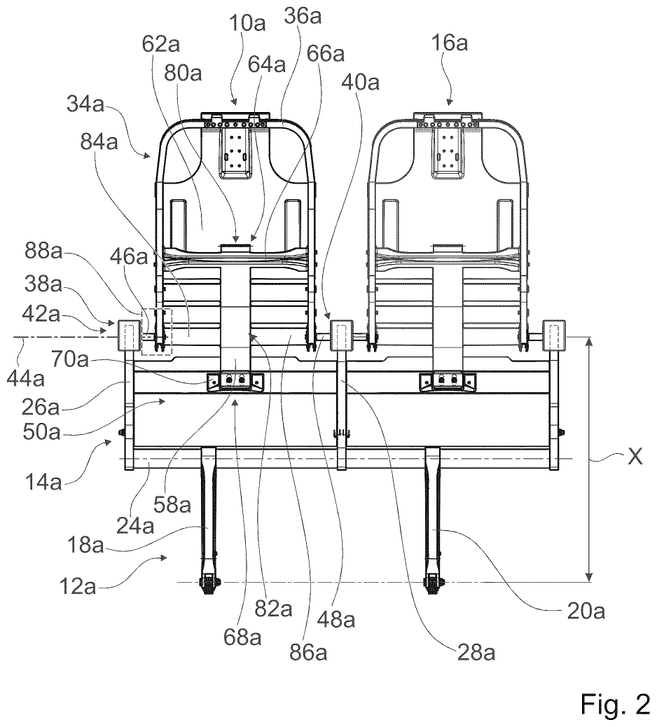

FIGS. 1 to 4 show a passenger seat device in a first exemplary embodiment. The passenger seat device is in this case part of a passenger seat 10a. The passenger seat 10a is embodied as an aircraft seat. The passenger seat 10a is mounted in an aircraft cabin of an aircraft in a mounted state. The passenger seat 10a is configured to be fixedly mounted on a cabin floor of the aircraft cabin in a mounted state. The passenger seat device has a mounting unit 12a. The passenger seat 10a can be mounted on the cabin floor of the aircraft cabin by means of the mounting unit 12a. The cabin floor forms a mounting plane. The passenger seat 10a is embodied as part of a passenger seat row 14a. The passenger seat 10a is preferably embodied as part of a passenger seat row 14a which comprises more than one passenger seat 10a. By way of example, the passenger seat row 14a with two passenger seats 10a, 16a is shown in the figures. The passenger seat row 14a shown by way of example has a second passenger seat 16a. The further passenger seat 16a is arranged adjacent to the first passenger seat 10a. The second passenger seat 16a is preferably embodied identically to the first passenger seat 10a, for which reason only the one passenger seat 10a is described in more detail below. In principle, it is also conceivable for the passenger seat row 14a to have three or more passenger seats 10a, 16a. In this case, the mounting unit 12a is embodied as a common mounting unit 12a of the passenger seats 10a, 16a of a passenger seat row 14a. The mounting unit 12a comprises two seat feet 18a, 20a. The seat feet 18a, 20a are each coupled to fastening rails, which are fixedly connected to the cabin floor, by means of fittings which are not illustrated in more detail. The fittings can be locked fixedly in the fastening rails.

The mounting unit 12a has two transverse beams 22a, 24a. The transverse beams 22a, 24a are embodied as support tubes. A front transverse beam 22a is arranged in a front region of the passenger seat 10a. A rear transverse beam 24a is arranged in a rear region of the passenger seat 10a. The transverse beams 22a, 24a run in a transverse direction of the passenger seat 10a. The transverse beams 22a, 24a extend at least substantially over an entire transverse extent of all passenger seats 10a of the passenger seat row 14a. The passenger seat device has two seat structure elements 26a, 28a. The two seat structure elements 26a, 28a are in each case arranged on one side of a seat region 30a of the passenger seat device. The two seat structure elements 26a, 28a are in each case arranged laterally with respect to a seat region 30a which the passenger seat 10a forms. The seat structure elements 26a, 28a are embodied as seat dividers. The seat structure elements 26a, 28a are arranged on the transverse beams 22a, 24a. The seat structure elements 26a, 28a are fastened to the transverse beams 22a, 24a at a distance from one another in the transverse direction. The seat structure elements 26a, 28a are connected in a positionally fixed manner to the transverse beams 22a, 24a. The seat structure elements 26a, 28a are in each case connected at their front end to the front transverse beam 22a. The seat structure elements 26a, 28a are in this case preferably connected in a force-fitting and/or form-fitting manner to the front transverse beam 22a. The seat structure elements 26a, 28a are embodied in a substantially L-shaped manner. The seat structure elements 26a, 28a in each case have a first partial region which is oriented substantially horizontally in a mounted state. The seat structure elements 26a, 28a in each case have a second partial region which is oriented substantially vertically in the mounted state. The second partial region of the seat structure elements 26a, 28a is arranged in a rear region of the passenger seat 10a. The second partial region of the seat structure elements 26a, 28a extends as far as a rear end of the seat structure elements 26a, 28a. The second partial region of the seat structure elements 26a, 28a forms a rear region of the seat structure elements 26a, 28a. The seat structure elements 26a, 28a therefore extend upwards in their rear region, away from the mounting unit 12a, in particular the mounting plane. The seat structure elements 26a, 28a extend upwards in their rear region substantially as far as an armrest height X. The seat structure elements 26a, 28a extend as far as an armrest height X of the passenger seat 10a. The armrest height X is 650 mm. In principle, it is preferably conceivable for the armrest height X to be in a range between 500 mm and 700 mm.

The seat structure elements 26a, 28a embodied as seat dividers are configured for the purpose of different components of the corresponding passenger seat 10a, 16a being fastened thereto, as is described at least partially in more detail below. In principle, it is also conceivable for the mounting unit 12a to have no or differently embodied seat structure elements 26a, 28a and for corresponding components of the passenger seat 10a, 16a to be attached differently to the mounting unit 12a.

The passenger seat device comprises a seat bottom 32a. The seat bottom 32a forms the seat region 30a. The seat bottom 32a forms a seat surface of the passenger seat 10a. The seat bottom 32a has a main body and an upholstery element fixedly attached to the main body. The upholstery element forms the seat surface of the passenger seat 10a. The seat bottom 32a is attached to the mounting unit 12a. The seat bottom 32a is attached in particular to the transverse beams 22a, 24a. The seat bottom 32a is coupled to the backrest 34a. The seat bottom 32a is coupled directly to the backrest 34a.

The passenger seat device comprises a backrest 34a. The backrest 34a is in this case configured such that a person sitting on the passenger seat 10a, whose part is the passenger seat device, can rest his/her back against the backrest 34a. The backrest 34a preferably has an upholstery which is not illustrated in more detail. The backrest 34a forms a backrest contact surface. The backrest 34a is arranged at a rear end of the seat bottom 32a. The backrest 34a is arranged pivotably with respect to the mounting unit 12a. The backrest 34a is attached to the seat structure elements 26a, 28a. The passenger seat 10a in this case forms a sitting direction. The sitting direction is defined as the direction in which a passenger sits on the passenger seat 10a. The sitting direction is orthogonal to a backrest surface of the backrest 34a and runs parallel to the mounting plane in the direction of a front end of the seat bottom 32a.

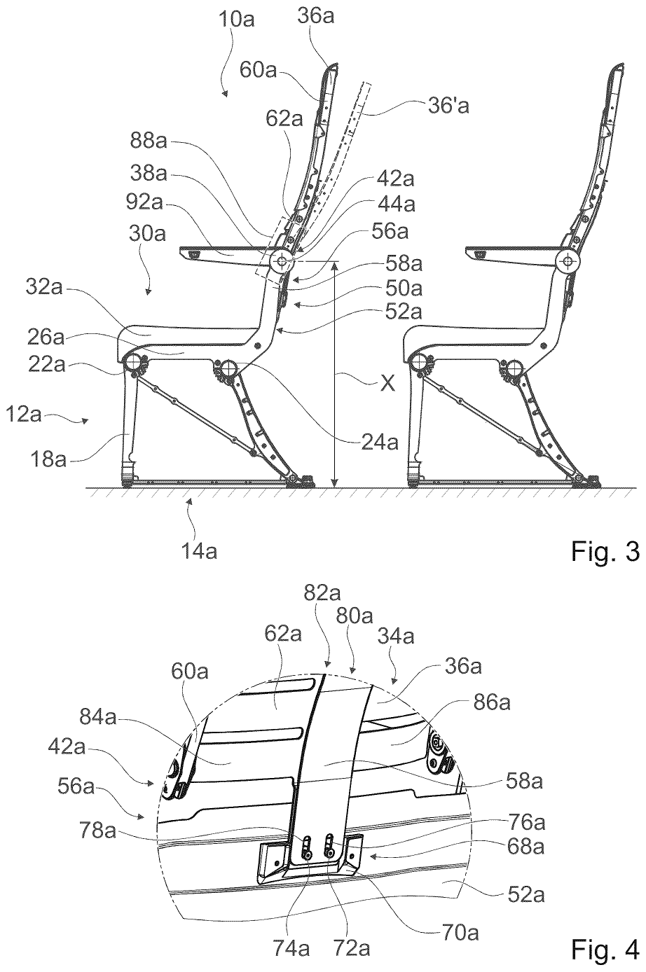

The backrest 34a is embodied in a pivotable manner. The backrest 34a is configured to be pivoted between an upright sitting position and a comfort position. The backrest 34a is configured to be pivoted relative to the mounting unit 12a. The backrest 34a is pivotable relative to the seat structure elements 26a, 28a. The backrest 34a has a pivotable backrest element 36a. The pivotable backrest element 36a is pivotably supported on the mounting unit 12a. The pivotable backrest element 36a is pivotably attached to the seat structure elements 26a, 28a. The seat structure elements 26a, 28a each have a bearing point 38a, 40a for supporting the backrest 34a. The bearing points 38a, 40a are configured such that the pivotable backrest element 36a is supported thereon. The pivotable backrest element 36a is pivotably attached to the seat structure elements 26a, 28a via the bearing points 38a, 40a. The bearing points 38a, 40a are embodied as bearing receptacles. The bearing points 38a, 40a define a position, in particular a height, of an axis of rotation 44a about which the backrest 34a, in particular the pivotable backrest element 36a, is pivotably supported. In FIG. 3, the backrest 34a is illustrated schematically in dashed form in the comfort position. The pivotable backrest element 36a is illustrated in dashed form in FIG. 3 as a pivotable backrest element 36a′ in the comfort position. The pivotable backrest element 36a′ is pivoted rearwardly from the upright sitting position by approximately 10 degrees counter to the sitting direction into its comfort position. In principle, it would also be conceivable for the pivotable backrest element 36a′ to be pivoted rearwardly from the upright sitting position merely by 5 degrees or by 8 degrees in the comfort position.

The passenger seat device has a bearing device 42a. The bearing device 42a is configured to support the backrest 34a pivotably between the upright sitting position and the comfort position. The bearing device 42a is configured to support the pivotable backrest element 36a pivotably between the upright sitting position and the comfort position. The bearing device 42a forms the axis of rotation 44a. The pivotable backrest element 36a is pivotable about the axis of rotation 44a by means of the bearing device 42a. The bearing device 42a has two bearing bolts 46a, 48a. The bearing bolts 46a, 48a form the axis of rotation 44a. The bearing bolts 46a, 48a are in each case connected to one of the bearing points 38a, 40a of one of the seat structure elements 26a, 28a. The bearing bolts 46a, 48a are preferably attached in a rotationally fixed manner to the respective bearing point 38a, 40a. The pivotable backrest element 36a is rotatably supported on the bearing bolts 46a, 48a. The pivotable backrest element 36a is preferably pivotably supported on the bearing bolts 46a, 48a via a slide bearing. In principle, it would also be conceivable for the pivotable backrest element 36a to be rotatably supported on the bearing bolts 46a, 48a by means of a roller bearing. In principle, it would likewise be conceivable for the bearing bolts 46a, 48a to be rotatably attached to the respective bearing points 38a, 40a of the seat structure elements 26a, 28a via a suitable supporting arrangement.

The pivotable backrest element 36a has a backrest frame 60a. The backrest frame 60a forms a load-bearing structure of the pivotable backrest element 36a. The backrest frame 60a is configured as a circumferential frame. The backrest frame 60a is preferably embodied in a substantially U-shaped manner. The backrest frame 60a has two lateral frame elements and an upper frame element which connects the two lateral frame elements at an upper end of the backrest frame 60a. The backrest frame 60a is preferably open at a lower end. The lower end of the backrest frame 60a forms a lower end of the pivotable backrest element 36a. The bearing bolts 46a, 48a are in each case attached to the backrest frame 60a of the pivotable backrest element 36a at a lower end of the backrest frame 60a at the facing lateral frame element.

The pivotable backrest element 36a has a shell element 62a. The shell element 62a is embodied as a plate-like element. The shell element 62a is formed from a fiber-reinforced plastic. The shell element 62a is formed, for example, from a GRP or a CFRP. The shell element 62a is configured to form the backrest contact surface of the pivotable backrest element 36a. The shell element 62a is arranged in an inner region of the pivotable backrest element 36a spanned by the backrest frame 60a. The shell element 62a is fixedly connected to the backrest frame 60a of the pivotable backrest element 36a. The shell element 62a is fixedly connected at least in partial regions to the lateral frame elements of the backrest frame 60a. The shell element 62a is preferably attached at an upper end to the upper frame element of the backrest frame 60a. The shell element 62a preferably forms a backrest contour of the pivotable backrest element 36a. The shell element 62a is configured such that an upholstery element of the backrest 34a is attached thereto.

The backrest 34a is embodied as a backrest with a high backrest pivot point. The backrest pivot point is formed by the axis of rotation 44a of the bearing device 42a. The backrest pivot point, i.e. the axis of rotation 44a of the bearing device 42a, is arranged above a knee region 50a of the passenger seat 10a. The knee region 50a of the passenger seat 10a extends from the cabin floor to a height of 650 mm. The knee region 50a is arranged as a region in which a passenger sitting behind the passenger seat 10a can arrange his knees.

In order to form the high backrest pivot point, the seat structure elements 26a, 28a form their bearing points 38a, 40a for supporting the backrest 34a in a high region. The seat structure elements 26a, 28a form their bearing points 38a, 40a in each case at an upper end. The seat structure elements 26a, 28a form their bearing points 38a, 40a at their upper end, facing away from the mounting plane, of the rear, second partial region. The bearing points 38a, 40a of the seat structure elements 26a, 28a are arranged above the knee region 50a. The bearing points 38a, 40a of the seat structure elements 26a, 28a are arranged at the armrest height X. The bearing points 38a, 40a for supporting the pivotable backrest element 36a define the axis of rotation 44a which is arranged above the knee region 50a of the backrest 34a.

The pivotable backrest element 36a forms the backrest 34a above the bearing points 38a, 40a of the seat structure elements 26a, 28a. The pivotable backrest element 36a forms merely an upper region of the backrest 34a. The pivotable backrest element 36a is embodied as an upper backrest element. The pivotable backrest element 36a forms the backrest contact surface of the backrest 34a in a region above the armrest height X. The pivotable backrest element 36a is preferably arranged substantially merely in a region above the armrest height X. Merely regions for attaching the backrest element 36a to the seat structure elements 26a, 28a extend below the armrest height X.

The backrest 34a has a lower backrest element 52a. The lower backrest element 52a is embodied rigidly. The lower backrest element 52a is preferably embodied immovably. The lower backrest element 52a forms a lower region of the backrest 34a. The lower backrest element 52a forms the backrest contact surface in the lower region of the backrest 34a. The lower backrest element 52a is fastened fixedly to the seat structure elements 26a, 28a. The lower backrest element 52a extends substantially between a height of the transverse beams 22a, 24a of the mounting unit 12a and a lower end of the pivotable backrest element 36a. The lower backrest element 52a preferably extends to just below the armrest height X. The lower backrest element 52a extends from a height of the transverse beams 22a, 24a to a height of approximately 450 mm to 700 mm, measured from the mounting plane. The lower backrest element 52a preferably extends to a height of 600 mm, measured from the mounting plane.

The lower backrest element 52a is formed by a shell element. The lower backrest element 52a is formed by a shell composed of a fiber-reinforced plastic. For example, it is conceivable for the lower backrest element 52a to be embodied by a GRP or a CFP shell. The lower backrest element 52a preferably has a slightly curved form. The lower backrest element 52a is connected laterally via in each case two fastening elements 54a to one of the seat structure elements 26a, 28a. In principle, it would also be conceivable for the lower backrest element 52a to be embodied at least partially in one piece with a seat bottom 32a, in particular a seat shell. In principle, it would likewise be conceivable for the lower backrest element 52a to be embodied at least partially or completely by a fabric.

The passenger seat device has a restoring module 56a. The restoring module 56a is configured to restore the backrest 34a from the comfort position into an upright sitting position. The restoring module 56a is configured to restore the backrest 34a from its pivoted sitting position into the upright sitting position. The restoring module 56a is configured to restore the pivotable backrest element 36a. The restoring module 56a is configured to restore the backrest 34a, in particular to restore the pivotable backrest element 36a, in order to provide a restoring force. The restoring module 56a is configured to restore the backrest 34a in order to exert a restoring force on the pivotable backrest element 36a. The restoring module 56a is arranged at least substantially in a region above the bearing points 38a, 40a of the seat structure elements 26a, 28a. The restoring module 56a is arranged at least substantially above, that is to say on a side facing away from the mounting plane, the armrest height X. The restoring module 56a is arranged at least for the most part above the knee region 50a of the backrest 34a. As a result of this arrangement of the restoring module 56a, the knee region 50a of the backrest 34a can preferably remain substantially free of components of the restoring module 56a. In particular, relatively large components of the restoring module 56a can advantageously be arranged above the armrest height X and therefore outside the knee region 50a of the backrest 34a.

The restoring module 56a has a leaf spring element 58a for providing a restoring force. In principle, it would also be conceivable for the restoring module 56a to have a plurality of leaf spring elements 58a for providing the restoring force. The leaf spring element 58a is configured to exert a spring force on the pivotable backrest element 36a in order to pivot said backrest element in the direction of its upright sitting position. The spring force of the leaf spring element 58a forms the restoring force of the restoring module 56a. The leaf spring element 58a is functionally arranged between the pivotable backrest element 36a and the mounting unit 12a. The leaf spring element 58a is configured to rest with a first side against the mounting unit 12a. The leaf spring element 58a is configured to rest with a second side against the backrest 34a, in particular on the pivotable backrest element 36a. As a result, the leaf spring element 58a can transmit a restoring force from the stationary mounting unit 12a to the pivotable backrest element 36a.

The leaf spring element 58a is embodied as an elongate component. The leaf spring element 58a is functionally arranged between the lower backrest element 52a and the pivotable backrest element 36a. The leaf spring element 58a is attached with its first, lower end to the lower backrest element 52a. The leaf spring element 58a rests with its lower end against the lower backrest element 52a. The leaf spring element 58a is attached in an upper region of the lower backrest element 52a. The leaf spring element 58a thus extends partially into a region below the axis of rotation 44a, that is to say the armrest height X. The leaf spring element 58a is attached with a second, upper end to the pivotable backrest element 36a. The leaf spring element 58a rests with its second, upper end against the pivotable backrest element 36a. The leaf spring element 58a preferably extends into a central region of the pivotable backrest element 52a.

For attaching the leaf spring element 58a to the pivotable backrest element 36a, the restoring module 56a has a first fastening unit 64a. The leaf spring element 58a is fixedly attached to the pivotable backrest element 36a via the first fastening unit 64a. The leaf spring element 58a is rigidly and immovably connected to the pivotable backrest element 36a via the first fastening unit 64a. In principle, it would also be conceivable for the leaf spring element 58a to be movably connected to the pivotable backrest element 36a via the first fastening unit 64a at least in one degree of freedom. Furthermore, it would likewise be conceivable for the leaf spring element 58a to abut merely against the pivotable backrest element 36a by way of its upper end. In this case, it would be conceivable for the leaf spring element 58a to slide with its upper end on the pivotable backrest element 36a, in particular on a rear side of the shell element 62a. The pivotable backrest element 36a has a transverse beam 66a. The transverse beam 66a is arranged in a region above the bearing points 38a, 40a. As viewed in the vertical direction, the transverse beam 66a is arranged approximately in a center of the pivotable backrest element 36a. The transverse beam 66a is attached between the lateral frame elements of the backrest frame 60a. The transverse beam 66a extends between the lateral frame elements of the backrest frame 60a. The transverse beam 66a is in each case fixedly connected to the respective lateral frame element of the backrest frame 60a. The transverse beam 66a is preferably screwed to the lateral frame elements of the backrest frame 60a. In principle, it would also be conceivable for the transverse beam 66a to be adhesively bonded to the lateral frame elements of the backrest frame 60a, or to be connected in another manner in a form-fitting, force-fitting and/or integrally bonded manner. The transverse beam 66a is preferably configured to reinforce the backrest frame 60a, in particular to reinforce the entire pivotable backrest element 36a. The transverse beam 66a can preferably be configured for the purpose of further attachment elements of the backrest 34a being fastened thereto. For example, it would be conceivable for a pivotable table element, a cup holder, a tablet holder or a high literature bag to be attached to the backrest 34a, in particular the pivotable backrest element 36a, on the transverse beam 66a. The leaf spring element 58a is attached to the transverse beam 66a for transmitting the restoring force. The leaf spring element 58a is attached directly to the transverse beam 66a via the fastening unit 64a. By means of the transverse beam 66a, the restoring force provided by the leaf spring element 58a can be transmitted uniformly to both sides of the pivotable backrest element 36a.

For attaching the leaf spring element 58a to the lower backrest element 52a, the restoring module 56a has a second fastening unit 68a. The leaf spring element 58a is fixedly attached to the lower backrest element 52a via the second fastening unit 68a. The leaf spring element 58a is movably attached to the lower backrest element 52a via the second fastening unit 68a. The second fastening unit 68a has a fastening main body 70a. The fastening main body 70a is fixedly attached to a rear side of the lower backrest element 52a. The fastening main body 70a of the second fastening unit 68a has a receptacle which is configured for receiving the leaf spring element 58a. The leaf spring element 58a is displaceably supported in the receptacle of the fastening main body 70a. The receptacle of the fastening main body 70a forms a displacement axis along which the leaf spring element 58a is displaceably supported. The displacement axis is oriented vertically in a mounted state. The fastening unit 68a has two fastening elements 72a, 74a which attach the leaf spring element 58a to the fastening main body 70a. The fastening elements 72a, 74a are embodied as fastening screws. In principle, it would also be conceivable for the fastening elements 72a, 74a to be embodied in a different manner. For attachment to the fastening main body 70a, the leaf spring element 58a has two through-grooves 76a, 78a. For attachment of the leaf spring element 58a, the fastening elements 72a, 74a are guided through the through-grooves 76a, 78a.

The leaf spring element 58a is at least partially integrated into the pivotable backrest element 36a. The leaf spring element 58a is partially integrated into the shell element 62a of the pivotable backrest element 36a. The leaf spring element 58a is configured to be received in the shell element 62a of the pivotable backrest element 36a. The shell element 62a of the pivotable backrest element 36a has a central region 80a. The central region 80a is arranged centrally between the lateral frame elements of the backrest frame 60a with respect to a transverse direction. The leaf spring element 58a is at least partially integrated into the central region 80a of the shell element 62a. The shell element 62a has, on its rear side in the central region 80a, a receiving region 82a for the leaf spring element 58a. The receiving region 82a extends in the central region 80a from a lower end of the shell element 62a into a region below the transverse beam 66a. In principle, it is likewise conceivable for the leaf spring element 58a to rest merely on the rear side of the shell element 62a in the central region 80a. It would likewise be conceivable for the leaf spring element 58a not to make contact with the shell element 62a in the central region 80a.

The pivotable backrest element 36a has in a lower region elastic ribs 84a, 86a which each extend laterally outwards from the central region 80a. By way of example, three elastic ribs 84a, 86a are in each case illustrated per side in the exemplary embodiment. The elastic ribs 84a, 86a each extend from the central region 80a as far as the lateral frame elements of the backrest frame 60a. The ribs 84a, 86a arranged adjacently on one side of the central region 80a are each at a distance from one another in the vertical direction. The elastic ribs 84a, 86a are each elastically deformable independently of one another. The elastic ribs 84a, 86a each have a form which is curved forwards in the sitting direction. The elastic ribs 84a, 86a are preferably formed in one piece with the shell element 62a, in particular with the central region 80a. In principle, it would likewise be conceivable for the elastic ribs 84a, 86a to be formed at least partially separately from the shell element 62a. In this case, it would be conceivable in particular for the ribs 84a, 86a to be formed partially as separate elements which are connected to the shell element 62a, in particular the central region 80a of the shell element 62a. In this case, it is conceivable in particular for the separately formed ribs 84a, 86a to be attachable to the shell element 62a in a demountable manner. As a result, the ribs 84a, 86a could be exchanged in an advantageously simple manner if they are damaged. Preferably, ribs 84a, 86a with different rigidities can be attached in a particularly simple manner to different points of the pivotable backrest element 36a by means of the ribs 84a, 86a which are formed in a demountable manner. As a result, the pivotable backrest element 36a can be embodied in a particularly simple manner and with different rigidities in different partial regions. Preferably, ribs 84a, 86a which are formed in a simple manner can be arranged at different points of the pivotable backrest element 36a by means of the ribs 84a, 86a which are formed in a demountable manner. As a result, the pivotable backrest element 36a can be formed in a particularly simple manner with different or adaptable ergonomies.

The restoring module 56a has a locking unit 88a. The locking unit 88a is configured to lock or unlock the restoring module 56a. The locking unit 88a is configured to lock the backrest 34a, that is to say the pivotable backrest element 36a, at least in the upright sitting position and in the comfort position. Preferably, it is likewise conceivable for the locking unit 88a to be configured to lock the pivotable backrest element 36a in further positions. The further positions of the pivotable backrest element 36a are in this case embodied in particular as pivoted positions which lie between the upright sitting position and the comfort position. The locking unit 88a has a locked state and an unlocked state. In its locked state, the locking unit 88a locks the restoring module 56a and the restoring module 56a cannot exert a restoring force on the pivotable backrest element 36a. In its unlocked state, the locking unit 88a unlocks the restoring module 56a and the restoring module 56a can exert the restoring force on the pivotable backrest element 36a. The locking unit 88a is configured to lock the pivotable backrest element 36a in its current position in its locked state. In the locked state of the locking unit 88a, the pivotable backrest element 36a is locked in its current position. In the locked state of the locking unit 88a, the pivotable backrest element 36a is not pivotable. In the locked state of the locking unit 88a, the pivotable backrest element 36a is preferably fixed relative to the mounting unit 12a. Preferably, the pivotable backrest element 36a is fixedly fixed relative to the seat structure elements 26a, 28a in the locked state of the locking unit 88a.

The locking unit 88a is functionally preferably arranged between the pivotable backrest element 36a, in particular the backrest frame 60a, and one of the seat structure elements 26a, 28a. In principle, it is likewise conceivable for the locking unit 88a to be functionally arranged between the backrest frame 60a and the two seat structure elements 26a, 28a. The locking unit 88a preferably has at least one locking element. The locking element of the locking unit 88a is preferably configured to lock the restoring module 56a in the locked state of the locking unit 88a. The locking element of the locking unit 88a is preferably configured to lock the pivotable backrest element 36a directly. The locking element of the locking unit 88a is configured to lock the pivotable backrest element 36a in a form-fitting manner. The locking element of the locking unit 88a is configured to engage in a corresponding form-fitting element of the locking unit 88a in a form-fitting manner in the locked state of the locking unit 88a. The locking unit 88a has a corresponding form-fitting element for each lockable position, that is to say for the upright sitting position and for the comfort position of the pivotable backrest element 36a. In principle, it would also be conceivable for the locking unit 88a to be configured to lock the pivotable backrest element 36a in a force-fitting manner and to have at least one force-fitting element for this purpose. In principle, it would likewise be conceivable for the locking unit 88a to be configured to lock the pivotable backrest element 36a in a force-fitting and form-fitting manner. The locking unit 88a has an actuating element 90a, by means of which the locking unit 88a can be adjusted from the locked state into the unlocked state. The actuating element 90a is configured to be actuated by a passenger sitting on the passenger seat 10a. The actuating element 90a is preferably embodied as a pushbutton. The actuating element 90a is coupled to the locking element of the locking unit 88a via a suitable connecting element, such as, in particular, a Bowden cable, in order to adjust said locking element between its locked position and unlocked position.

The locking unit 88a is arranged above the knee region 50a of the backrest 34a. The locking unit 88a is preferably arranged in a region above the bearing points 38a, 40a of the seat structure elements 26a, 28a. The locking unit 88a is preferably arranged substantially, that is to say for the most part, above the armrest height X. The locking unit 88a is arranged in a region of the pivotable backrest element 36a. The locking unit 88a is preferably arranged outside a region of the lower backrest element 52a. In particular, the locking element and the correspondingly embodied form-fitting elements of the locking unit 88a for locking the pivotable backrest element 36a are arranged above the bearing points 38a, 40a and the armrest height X. Individual constituent parts of the locking unit 88a, such as, in particular, the actuating element 90a, and a Bowden cable can also be arranged partially below the armrest height X.

The passenger seat device has two armrests 92a, 94a. The armrests 92a, 94a are part of the passenger seat 10a of the passenger seat row 14a. The armrests 92a, 94a are in each case arranged laterally with respect to the seat region 30a of the passenger seat 10a. The armrests 92a, 94a are attached at the armrest height X. The armrests 92a, 94a are attached to the mounting unit 12a with a rear end at the armrest height X. The armrests 92a, 94a are attached via the seat structure elements 26a, 28a. The armrests 92a, 94a are attached to the passenger seat 10a via the bearing points 38a, 40a of the seat structure elements 26a, 28a embodied as seat dividers. The armrests 92a, 94a are attached to the seat structure elements 26a, 28a via the bearing bolts 46a, 48a of the bearing device 42a of the backrest 34a. The armrests 92a, 94a are attached to the seat structure elements 26a, 28a via the same bearing bolts 46a, 48a as the pivotable backrest element 36a. The armrests 92a, 94a are preferably pivotably attached to the seat structure elements 26a, 28a. The armrests 92a, 94a are pivotable via the same axis of rotation 44a as the pivotable backrest element 36a. In principle, it would also be conceivable for the armrests 92a, 94a to be attached in a rotationally fixed manner to the seat structure elements 26a, 28a. The actuating element 90a of the locking unit 88a is preferably introduced into one of the armrests 92a, 94a.

Alternatively, it would also be conceivable for the leaf spring element 58a to be attached directly to the mounting unit 12a. In this case, it would be conceivable for the leaf spring element 58a to be attached directly to the rear transverse beam 24a of the mounting unit 12a instead of to the lower backrest element 52a. In this case, it would be conceivable for the leaf spring element 58a to be arranged in a lateral region, directly in the region of one of the laterally arranged seat structure elements 26a, 28a. As a result, a central region of the knee region 50a of the backrest 34 could advantageously be embodied free of the leaf spring element 58a.

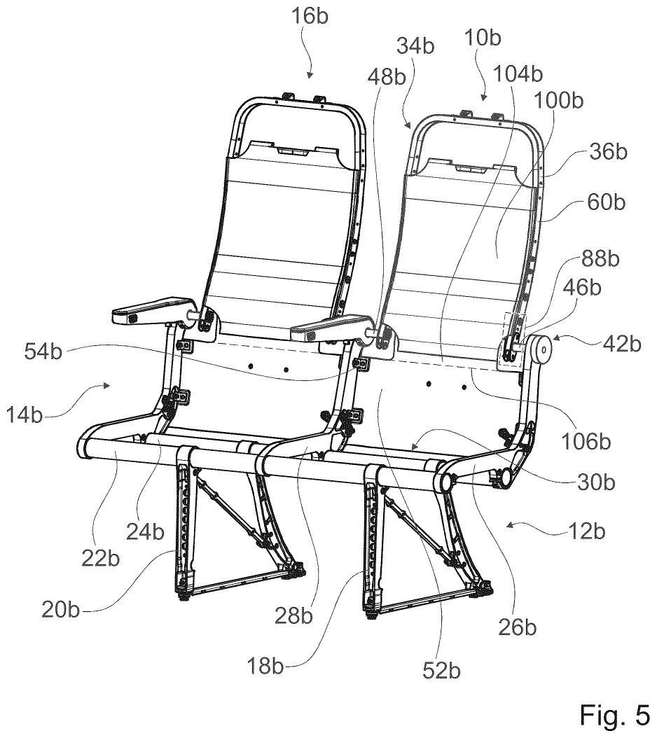

FIGS. 5 to 10 show five further exemplary embodiments of the invention. The following descriptions and the drawings are restricted substantially to the differences between the exemplary embodiments, wherein, with respect to components with the same designation, in particular with respect to components with the same reference signs, reference can in principle also be made to the drawings and/or the description of the other exemplary embodiments, in particular of FIGS. 1 to 4. In order to differentiate between the exemplary embodiments, the letter a is added after the reference signs of the exemplary embodiment in FIGS. 1 to 4. In the exemplary embodiments of FIGS. 5 to 10, the letter a is replaced by the letters b to f.

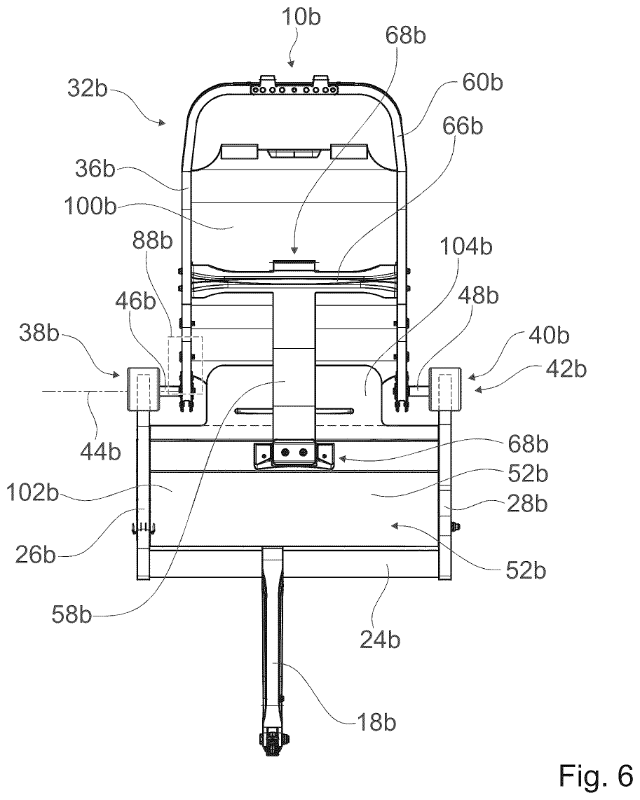

FIGS. 5 and 6 show a second exemplary embodiment of a passenger seat device according to the invention. The passenger seat device is in this case part of a passenger seat 10b. The passenger seat 10b is mounted in an aircraft cabin of an aircraft in a mounted state. The passenger seat device has a mounting unit 12b. The passenger seat 10b can be mounted on the cabin floor of the aircraft cabin by means of the mounting unit 12b. The passenger seat 10b is embodied as part of a passenger seat row 14b. The passenger seat row 14b shown by way of example has a second passenger seat 16b. In this case, the mounting unit 12b is embodied as a common mounting unit of the passenger seats 10b, 16b of a passenger seat row 14b. The mounting unit 12b comprises two seat feet 18b, 20b. The mounting unit 12b has two transverse beams 22b, 24b.

The passenger seat device has two seat structure elements 26b, 28b. The two seat structure elements 26b, 28b are in each case arranged on one side of a seat region 30b of the passenger seat device. The two seat structure elements 26b, 28b are in each case arranged laterally with respect to a seat region 30b which the passenger seat 10b forms. The seat structure elements 26b, 28b are embodied as seat dividers. The seat structure elements 26b, 28b are arranged on the transverse beams 22b, 24b. The seat structure elements 26b, 28b are embodied in a substantially L-shaped manner. The seat structure elements 26b, 28b therefore extend upwards in their rear region, away from the mounting unit 12b, in particular the mounting plane. The seat structure elements 26b, 28b extend upwards in their rear region substantially as far as an armrest height X. The seat structure elements 26b, 28b extend as far as an armrest height X of the passenger seat 10b.

The passenger seat device comprises a backrest 34b. The backrest 34b is configured such that a person sitting on the passenger seat 10b, whose part is the passenger seat device, can rest his/her back against the backrest 34b. The backrest 34b is arranged pivotably with respect to the mounting unit 12b. The backrest 34b is attached to the seat structure elements 26b, 28b. The backrest 34b is configured to be pivoted between an upright sitting position and a comfort position. The backrest 34b has a pivotable backrest element 36b. The pivotable backrest element 36b is pivotably supported on the mounting unit 12b. The pivotable backrest element 36b is pivotably attached to the seat structure elements 26b, 28b. The seat structure elements 26b, 28b each have a bearing point 38b, 40b for supporting the backrest 34b. The bearing points 38b, 40b are configured such that the pivotable backrest element 36b is supported thereon.

The passenger seat device has a bearing device 42b. The bearing device 42b is configured to support the backrest 34b pivotably between the upright sitting position and the comfort position. The bearing device 42b is configured to support the pivotable backrest element 36b pivotably between the upright sitting position and the comfort position. The bearing device 42b forms the axis of rotation 44b. The pivotable backrest element 36b is pivotable about the axis of rotation 44b by means of the bearing device 42b. The bearing device 42b has two bearing bolts 46b, 48b. The bearing bolts 46b, 48b form the axis of rotation 44b. The bearing bolts 46b, 48b are in each case connected to one of the bearing points 38b, 40b of one of the seat structure elements 26b, 28b.

The pivotable backrest element 36b has a backrest frame 60b. The backrest frame 60b forms a load-bearing structure of the pivotable backrest element 36b. The backrest frame 60b is configured as a circumferential frame. The backrest frame 60b is preferably embodied in a substantially U-shaped manner. The backrest frame 60b has two lateral frame elements and an upper frame element which connects the two lateral frame elements at an upper end of the backrest frame 60b. The backrest frame 60b is preferably open at a lower end. The lower end of the backrest frame 60b forms a lower end of the pivotable backrest element 36b. The bearing bolts 46b, 48b are in each case attached to the backrest frame 60b of the pivotable backrest element 36b at a lower end of the backrest frame 60b at the facing lateral frame element.

The backrest 34b is embodied as a backrest with a high backrest pivot point. The backrest pivot point, i.e. the axis of rotation 44b of the bearing device 42b, is arranged above a knee region 50b of the passenger seat 10b. In order to form the high backrest pivot point, the seat structure elements 26b, 28b form their bearing points 38b, 40b for supporting the backrest 34b in a high region. The bearing points 38b, 40b of the seat structure elements 26b, 28b are arranged above the knee region 50b. The bearing points 38b, 40b of the seat structure elements 26b, 28b are arranged at the armrest height X.

In contrast to the first exemplary embodiment, the pivotable backrest element 36b has a fabric 100b. The fabric 100b is spanned on the backrest frame 60b. The fabric 100b is formed by a textile which is spanned between the lateral frame elements of the backrest frame 60b. In principle, it is conceivable for the fabric 100b also to be attached to an upper frame element of the backrest frame 60b. The fabric 100b extends from a lower end of the backrest frame 60b into an upper end region of the backrest frame 60b.

The backrest 34b has a lower backrest element 52b. The lower backrest element 52b is embodied rigidly. The lower backrest element 52b is preferably embodied immovably. The lower backrest element 52b forms a lower region of the backrest 34b. The lower backrest element 52b forms the backrest contact surface in the lower region of the backrest 34b. The lower backrest element 52b is fastened fixedly to the seat structure elements 26b, 28b. The lower backrest element 52b is formed by a shell element. The lower backrest element 52b is embodied from a fiber-reinforced plastic. The lower backrest element 52b is preferably formed from a plurality of layers of a fiber-reinforced plastic. For example, it is conceivable for the lower backrest element 52b to be embodied by one or more GRP layers or by one or more CFP layers. The lower backrest element 52b has a main region 102b. The main region 102b substantially forms the backrest contact surface of the lower backrest element 52b and is embodied substantially as in the case of the lower backrest element of the first exemplary embodiment. In contrast to the first exemplary embodiment, the lower backrest element 52b has a lip 104b at its upper end. The lip 104b directly adjoins an upper end of the main region 102b of the lower backrest element 52b. The lip 104b forms an upper end region of the lower backrest element 52b. The lip 104b is embodied in one piece with the remainder of the lower backrest element 52b. The lip 104b is arranged centrally at the upper end of the lower backrest element 52b in the transverse direction. In principle, it would also be conceivable for the lower backrest element 52b also to have two or more eccentrically arranged lips 104b which are arranged at its upper end. If the lower backrest element 52b has a plurality of lips 104b at its upper end, said lips are preferably arranged symmetrically with respect to a central axis of the lower backrest element 52b. The lip 104b of the lower backrest element 52b extends as far as above the bearing points 38b, 40b for supporting the pivotable backrest element 36b. The lip 104b of the lower backrest element 52b extends as far as behind a region of the pivotable backrest element 36b, in particular as far as behind the fabric 100b of the pivotable backrest element 36b. The lip 104b is configured for the purpose that the fabric 100b of the pivotable backrest element 36b can be attached thereto by way of its lower end. The fabric 100b is attached by way of its lower end to a front side 106b of the lip 104b of the lower backrest element 52b. The fabric 100b is preferably detachably attached to the front side 106b of the lip 104b by means of a loop and hook strap. In principle, it is also conceivable for the fabric 100b to be connected, for example adhesively bonded, to the lip 104b of the lower backrest element 52b in a different manner.

The passenger seat device has a restoring module 56b. The restoring module 56b is configured to restore the backrest 34b from the comfort position into an upright sitting position. The restoring module 56b is configured to restore the backrest 34b from the pivoted sitting position into the upright sitting position. The restoring module 56b is arranged at least substantially in a region above the bearing points 38b, 40b of the seat structure elements 26b, 28b. The restoring module 56b is arranged at least substantially above, that is to say on a side facing away from the mounting plane, the armrest height X. The restoring module 56b is arranged at least for the most part above the knee region 50b of the backrest 34b.

The restoring module 56b has a leaf spring element 58b for providing a restoring force. The leaf spring element 58b is configured to exert a spring force on the pivotable backrest element 36b in order to pivot said backrest element in the direction of the upright sitting position. The leaf spring element 58b is attached with its first, lower end to the lower backrest element 52b. The leaf spring element 58b is attached in an upper region of the lower backrest element 52b. The leaf spring element 58b is attached below the lip 104b in the main region 102b of the lower backrest element 52b.

For attaching the leaf spring element 58b to the pivotable backrest element 36b, the restoring module 56b has a first fastening unit 64b. The leaf spring element 58b is fixedly attached to the pivotable backrest element 36b via the first fastening unit 64b. The pivotable backrest element 36b has a transverse beam 66b. The transverse beam 66b is arranged in a region above the bearing points 38b, 40b. The transverse beam 66b is arranged behind the fabric 100b. The leaf spring element 58b is attached directly to the transverse beam 66b via the fastening unit 64b. For attaching the leaf spring element 58b to the lower backrest element 52b, the restoring module 56b has a second fastening unit 68b. The leaf spring element 58b is fixedly attached to the lower backrest element 52b via the second fastening unit 68b. The leaf spring element 58b is movably attached to the lower backrest element 52b via the second fastening unit 68b.

The restoring module 56b has a locking unit 88b. The locking unit 88b is configured to lock or unlock the restoring module 56b. The locking unit 88b is configured to lock the backrest 34b, that is to say the pivotable backrest element 36b, at least in the upright sitting position and in the comfort position. The locking unit 88b is functionally preferably arranged between the pivotable backrest element 36b, in particular the backrest frame 60b, and one of the seat structure elements 26b, 28b. The locking unit 88b is arranged above the knee region 50b of the backrest 34b. The locking unit 88b is preferably arranged in a region above the bearing points 38b, 40b of the seat structure elements 26b, 28b. The locking unit 88b is preferably arranged substantially, that is to say for the most part, above the armrest height X.

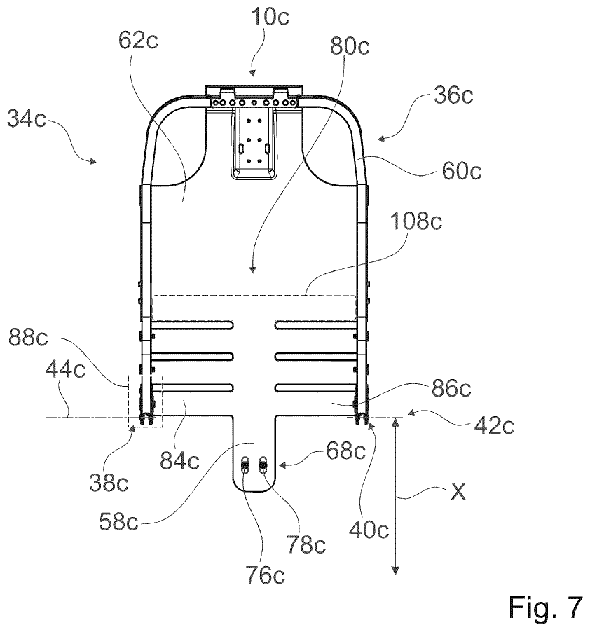

FIG. 7 shows a third exemplary embodiment of a passenger seat device according to the invention. The passenger seat device is part of a partially illustrated passenger seat 10c. The passenger seat 10c is embodied substantially identically to the passenger seat of the first exemplary embodiment from FIGS. 1-4 and is therefore not intended to be described in more detail here. The passenger seat device has a mounting unit which is not illustrated in more detail. The passenger seat device has two seat structure elements which are not illustrated in more detail and are connected to the mounting unit and are embodied as seat dividers. The seat structure elements extend as far as an armrest height X of the passenger seat 10c.

The passenger seat device comprises a backrest 34c. The backrest 34c forms a backrest contact surface. The backrest 34c is attached to the seat structure elements. The backrest 34c is embodied in a pivotable manner. The backrest 34c is configured to be pivoted between an upright sitting position and a comfort position. The backrest 34c has a pivotable backrest element 36c. The backrest 34c is embodied as a backrest with a high backrest pivot point. The backrest pivot point is formed by an axis of rotation 44c of a bearing device 42c. The pivotable backrest element 36c is pivotably attached to the seat structure elements. The seat structure elements each have a bearing point for supporting the backrest 34c. The pivotable backrest element 36c has a backrest frame 60c. The backrest frame 60c forms a load-bearing structure of the pivotable backrest element 36c. The pivotable backrest element 36c has a shell element 62c. The shell element 62c is embodied as a plate-like element. The shell element 62c is formed from a fiber-reinforced plastic. The shell element 62c is formed, for example, from a GRP or a CFRP. The shell element 62c is configured to form the backrest contact surface of the pivotable backrest element 36c. The shell element 62c is fixedly connected to the backrest frame 60c of the pivotable backrest element 36c. The shell element 62c preferably forms a backrest contour of the pivotable backrest element 36c. The backrest 34c has a lower backrest element which is not illustrated in more detail. The lower backrest element is likewise formed by a shell element.

The passenger seat device has a restoring module 56c. The restoring module 56c is configured to restore the backrest 34c from the comfort position into an upright sitting position. The restoring module 56c is configured to restore the pivotable backrest element 36c. The restoring module 56c is configured to restore the backrest 34c, in particular to restore the pivotable backrest element 36c, in order to provide a restoring force. The restoring module 56c has a leaf spring element 58c for providing a restoring force. In contrast to the first exemplary embodiment, the leaf spring element 58c is at least partially formed in one piece with the pivotable backrest element 36c. The leaf spring element 58c is formed in one piece with the shell element 62c of the pivotable backrest element 36c. The leaf spring element 58c is formed by a central region 80c of the shell element 62c. The leaf spring element 58c is integrated into the central region 80c of the shell element 62c. The leaf spring element 58c is embedded in fiber-reinforced layers of the shell element 62c. The leaf spring element 58c is preferably formed as a leaf spring element which is inserted into the shell element 62c in a production method. In principle, however, it would also be conceivable for the leaf spring element 58c to be formed by the fiber layers of the shell element 62c in the central region 80c itself. At an upper end, the leaf spring element 58c formed in one piece with the shell element 62c forms a transverse stiffening element 108c. The transverse stiffening element 108c is formed in one piece with the leaf spring element 58c and thus the shell element 62c. The transverse stiffening element 108c is configured, like the transverse beam of the first exemplary embodiment, for better introduction of the restoring force into the pivotable backrest element 36c. In this exemplary embodiment, the pivotable backrest element 36c preferably has no separate transverse beam. In principle, it would also be conceivable for the leaf spring element 58c not to have a transverse stiffening element 108c. The pivotable backrest element 36c has in a lower region elastic ribs 84c, 86c which each extend laterally outwards from the central region 80c. The outwardly extending elastic ribs 84c, 86c can preferably likewise be formed in one piece with the leaf spring element 58c. For attaching the leaf spring element 58c to the lower backrest element 52c, the restoring module 56c has a fastening unit 68c which is formed in the same way as in the first exemplary embodiment. The fastening unit 68c is formed at least by through-grooves 76c, 78c which are formed as elongated holes in a lower end of the leaf spring element 58c.

The restoring module 56c has a locking unit which is not illustrated in more detail here and is embodied substantially in the same way as in the preceding exemplary embodiments. The locking unit is functionally preferably arranged between the pivotable backrest element 36c, in particular the backrest frame 60c, and one of the seat structure elements. The locking unit is preferably arranged in a region above the bearing points of the seat structure elements. The locking unit is preferably arranged substantially, that is to say for the most part, above the armrest height X.

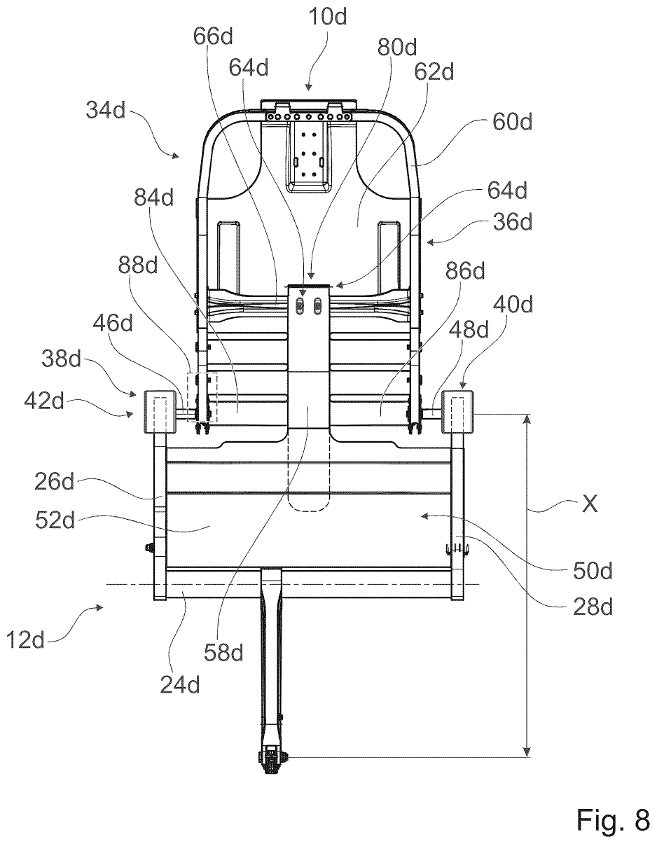

FIG. 8 shows a fourth exemplary embodiment of a passenger seat device according to the invention. The passenger seat device is part of a partially illustrated passenger seat 10d. The passenger seat device has a mounting unit 12d. The passenger seat 10d can be mounted on the cabin floor of the aircraft cabin by means of the mounting unit 12d. The mounting unit 12d has two transverse beams 24d. The passenger seat device has two seat structure elements 26d, 28d. The two seat structure elements 26d, 28d are in each case arranged on one side of a seat region 30d of the passenger seat device. The two seat structure elements 26d, 28d are in each case arranged laterally with respect to a seat region 30d which the passenger seat 10d forms. The seat structure elements 26d, 28d are embodied as seat dividers. The seat structure elements 26d, 28d are arranged on the transverse beams 24d. The seat structure elements 26d, 28d are embodied in a substantially L-shaped manner. The seat structure elements 26d, 28d therefore extend upwards in their rear region, away from the mounting unit 12d, in particular the mounting plane. The seat structure elements 26d, 28d extend upwards in their rear region substantially as far as an armrest height X. The seat structure elements 26d, 28d extend as far as an armrest height X of the passenger seat 10d.

The passenger seat device comprises a backrest 34d. The backrest 34d is arranged pivotably with respect to the mounting unit 12d. The backrest 34d is attached to the seat structure elements 26d, 28d. The backrest 34d is configured to be pivoted between an upright sitting position and a comfort position. The backrest 34d has a pivotable backrest element 36d. The pivotable backrest element 36d is pivotably supported on the mounting unit 12d. The seat structure elements 26d, 28d each have a bearing point 38d, 40d for supporting the pivotable backrest element 36d. The passenger seat device has a bearing device 42d. The bearing device 42d is configured to support the backrest 34d pivotably between the upright sitting position and the comfort position. The bearing device 42d is configured to support the pivotable backrest element 36d pivotably between the upright sitting position and the comfort position. The bearing device 42d forms the axis of rotation 44d. The bearing device 42d has two bearing bolts 46d, 48d. The bearing bolts 46d, 48d form the axis of rotation 44d. The bearing bolts 46d, 48d are in each case connected to one of the bearing points 38d, 40d of one of the seat structure elements 26d, 28d. The backrest 34d is embodied as a backrest with a high backrest pivot point. The backrest pivot point, i.e. the axis of rotation 44d of the bearing device 42d, is arranged above a knee region 50d of the passenger seat 10d. In order to form the high backrest pivot point, the seat structure elements 26d, 28d form their bearing points 38d, 40d for supporting the backrest 34d in a high region. The bearing points 38d, 40d of the seat structure elements 26d, 28d are arranged above the knee region 50d. The bearing points 38d, 40d of the seat structure elements 26d, 28d are arranged at the armrest height X.

The pivotable backrest element 36d has a backrest frame 60d. The backrest frame 60d forms a load-bearing structure of the pivotable backrest element 36d. The pivotable backrest element 36d has a shell element 62d. The shell element 62d is formed from a fiber-reinforced plastic. The shell element 62d is fixedly connected to the backrest frame 60d of the pivotable backrest element 36d. The shell element 62d of the pivotable backrest element 36d has a central region 80d. The pivotable backrest element 36d has in a lower region elastic ribs 84d, 86d which each extend laterally outwards from the central region 80d. The elastic ribs 84d, 86d are preferably formed in one piece with the shell element 62d, in particular with the central region 80d.

The backrest 34d has a lower backrest element 52d. The lower backrest element 52d forms a lower region of the backrest 34d. The lower backrest element 52d forms the backrest contact surface in a lower region of the backrest 34d. The lower backrest element 52d is fastened fixedly to the seat structure elements 26d, 28d. The lower backrest element 52d extends substantially between a height of the transverse beams 22d, 24d of the mounting unit 12d and a lower end of the pivotable backrest element 36d. The lower backrest element 52d is formed by a shell element. The lower backrest element 52d is formed by a shell composed of a fiber-reinforced plastic.

The passenger seat device has a restoring module 56d. The restoring module 56d is configured to restore the backrest 34d from the comfort position into an upright sitting position. The restoring module 56d is configured to restore the pivotable backrest element 36d. The restoring module 56d is configured to restore the backrest 34d, in particular to restore the pivotable backrest element 36d, in order to provide a restoring force. The restoring module 56d has a leaf spring element 58d for providing a restoring force. In contrast to the preceding exemplary embodiments, the leaf spring element 58d is at least partially formed in one piece with the lower backrest element 52d.

The leaf spring element 58d is formed in one piece with the lower backrest element 52d embodied as a shell element. The leaf spring element 58d is formed by a central region of the lower backrest element 52d. The leaf spring element 58d is partially integrated into the lower shell element. The leaf spring element 58d is embedded in fiber-reinforced layers of the lower backrest element 52d embodied as a shell element. The leaf spring element 58d is preferably formed as a leaf spring element which is inserted into the lower backrest element 52d in a production method. The leaf spring element 58d extends from the lower backrest element 52d into a center of the pivotable backrest element 36d.

For attaching the leaf spring element 58d to the pivotable backrest element 36d, the restoring module 56d has a first fastening unit 64d. The pivotable backrest element 36d has a transverse beam 66d. The transverse beam 66d is arranged in a region above the bearing points 38d, 40d. The leaf spring element 58d is attached directly to the transverse beam 66d via the fastening unit 64d. The leaf spring element 58d is connected to the transverse beam 66d in an axially movable manner. The leaf spring element 58d has two through-grooves which are embodied as elongated holes and via which the leaf spring element 58d is displaceably connected to the transverse beam 66d via two fastening elements, for example screws, of the fastening unit 64d. The first fastening unit 64d for attaching the leaf spring element 58d can preferably be embodied in an equivalent manner to the second fastening unit of the first exemplary embodiment for attaching the leaf spring element to the lower backrest element 52d.

The restoring module 56d has a locking unit 88d. The locking unit 88d is configured to lock or unlock the restoring module 56d. The locking unit 88d is configured to lock the backrest 34d, that is to say the pivotable backrest element 36d, at least in the upright sitting position and in the comfort position. The locking unit 88d is functionally preferably arranged between the pivotable backrest element 36d, in particular the backrest frame 60d, and one of the seat structure elements 26d, 28d. The locking unit 88d is arranged above the knee region 50d of the backrest 34d. The locking unit 88d is preferably arranged in a region above the bearing points 38d, 40d of the seat structure elements 26d, 28d. The locking unit 88d is preferably arranged substantially, that is to say for the most part, above the armrest height X.

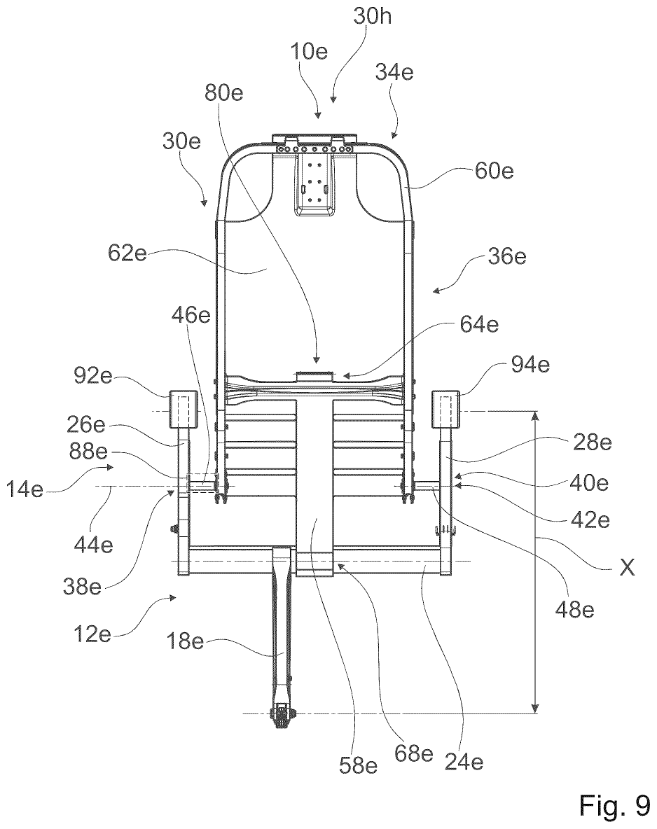

FIG. 9 shows a fifth exemplary embodiment of a passenger seat device according to the invention. The passenger seat device is part of a partially illustrated passenger seat 10e. The passenger seat device has a mounting unit 12e. The passenger seat 10e can be mounted on the cabin floor of the aircraft cabin by means of the mounting unit 12e. The mounting unit 12e has two transverse beams 24e. The passenger seat device has two seat structure elements 26e, 28e. The two seat structure elements 26e, 28e are in each case arranged on one side of a seat region 30e of the passenger seat device. The two seat structure elements 26e, 28e are in each case arranged laterally with respect to a seat region 30e which the passenger seat 10e forms. The seat structure elements 26e, 28e are embodied as seat dividers. The seat structure elements 26e, 28e are embodied in a substantially L-shaped manner. The seat structure elements 26e, 28e in each case have a first partial region which is oriented substantially horizontally in the mounted state. The seat structure elements 26e, 28e in each case have a second partial region which is oriented substantially vertically in the mounted state. The second partial region of the seat structure elements 26e, 28e is arranged in a rear region of the passenger seat 10e. The seat structure elements 26e, 28e are arranged on the transverse beams 24e. The seat structure elements 26e, 28e therefore extend upwards in their rear region, away from the mounting unit 12e, in particular the mounting plane. The seat structure elements 26e, 28e extend upwards in their rear region substantially as far as an armrest height X. The seat structure elements 26e, 28e extend as far as an armrest height X of the passenger seat 10e.

The passenger seat device comprises a backrest 34e. The backrest 34e is arranged pivotably with respect to the mounting unit 12e. The backrest 34 is attached to the seat structure elements 26e, 28e. The backrest 34e is configured to be pivoted between an upright sitting position and a comfort position. The backrest 34e has a pivotable backrest element 36e. In contrast to the preceding exemplary embodiments, the backrest 34e is embodied as a backrest with a lower backrest pivot point. The backrest 34e preferably has no lower backrest element which is rigidly connected to the seat structure elements 26e, 28e. The pivotable backrest element 36e extends as far as into a region of the seat bottom 32e of the passenger seat. The pivotable backrest element 36e extends as far as into a region below a seat surface formed by the seat bottom 32e. The pivotable backrest element 36e is pivotably supported in a region below the armrest height X.

The pivotable backrest element 36e is pivotably attached to the seat structure elements 26e, 28e. The seat structure elements 26e, 28e each have a bearing point 38e, 40e for supporting the pivotable backrest element 36e. In order to form the lower backrest pivot point, the seat structure elements 26e, 28e form their bearing points 38e, 40e for supporting the pivotable backrest element 36e in a lower region. The bearing points 38e, 40e of the seat structure elements 26e, 28e are preferably arranged in a lower third of the seat structure elements 26e, 28e, in particular in a lower third of the second partial region of the seat structure elements 26e, 28e. The bearing points 38e, 40e of the seat structure elements 26e, 28e are arranged in a knee region 50e of the backrest 34e. The bearing points 38e, 40e of the seat structure elements 26e, 28e are arranged below the armrest height X.

The passenger seat device has a bearing device 42e. The bearing device 42e is configured to support the pivotable backrest element 36e pivotably between the upright sitting position and the comfort position. The bearing device 42e has an axis of rotation 44e. The axis of rotation 44e for supporting the pivotable backrest element 36e is arranged below the armrest height X. The bearing device 42e has two bearing bolts 46e, 48e. The bearing bolts 46e, 48e form the axis of rotation 44e. The bearing bolts 46e, 48e are in each case connected to one of the bearing points 38e, 40e of one of the seat structure elements 26e, 28e.

The pivotable backrest element 36e has a backrest frame 60e. The backrest frame 60e extends as far as into a region below the bearing points 38e, 40e of the seat structure elements 26e, 28e. The pivotable backrest element 36e has a shell element 62e which is fixedly connected to the backrest frame 60e of the pivotable backrest element 36e. The shell element 62e of the pivotable backrest element 36e has a central region 80e and in a lower region elastic ribs 84e, 86e which each extend laterally outwards from the central region 80e.

The passenger seat device has a restoring module 56e. The restoring module 56e is configured to restore the backrest 34e from the comfort position into an upright sitting position. The restoring module 56e is configured to restore the pivotable backrest element 36e. The restoring module 56e has a leaf spring element 58e for providing a restoring force. The leaf spring element 58e is functionally arranged between the pivotable backrest element 36e and the mounting unit 12e. The leaf spring element 58e is attached with its first, lower end, in contrast to the other exemplary embodiments, directly to the mounting unit 12e, in particular to the rear transverse beam 24e. The leaf spring element 58e rests with its lower end against the rear transverse beam 24e of the mounting unit 12e. For attaching the leaf spring element 58e to the rear transverse beam 24e, the restoring module 56e has a fastening unit 68e. The leaf spring element 58e is fixedly attached to the mounting unit 12e via the fastening unit 68e. The fastening unit 68e preferably has a clamp element which encloses the rear transverse beam 24e and is thus fixedly attached to the transverse beam 24e. The leaf spring element 58e is preferably movably attached to the rear transverse beam 24e in at least one vertical direction via the fastening unit 68e. The leaf spring element 58e is attached with a second, upper end to the pivotable backrest element 36e. For attaching the leaf spring element 58e to the pivotable backrest element 36e, the restoring module 56e has a fastening unit 64e.

The restoring module 56e has a locking unit 88e. The locking unit 88e is configured to lock or unlock the restoring module 56e. The locking unit 88e is preferably arranged in a region above the bearing points 38e, 40e of the seat structure elements 26e, 28e. The entire restoring module 56e, except for the partial region of the leaf spring element 58e which extends as far as the transverse beam 24e of the mounting unit 12e, is arranged above the bearing points 38e, 40e of the seat structure elements 26e, 28e, that is to say above the axis of rotation 44e of the pivotable backrest element 36e.

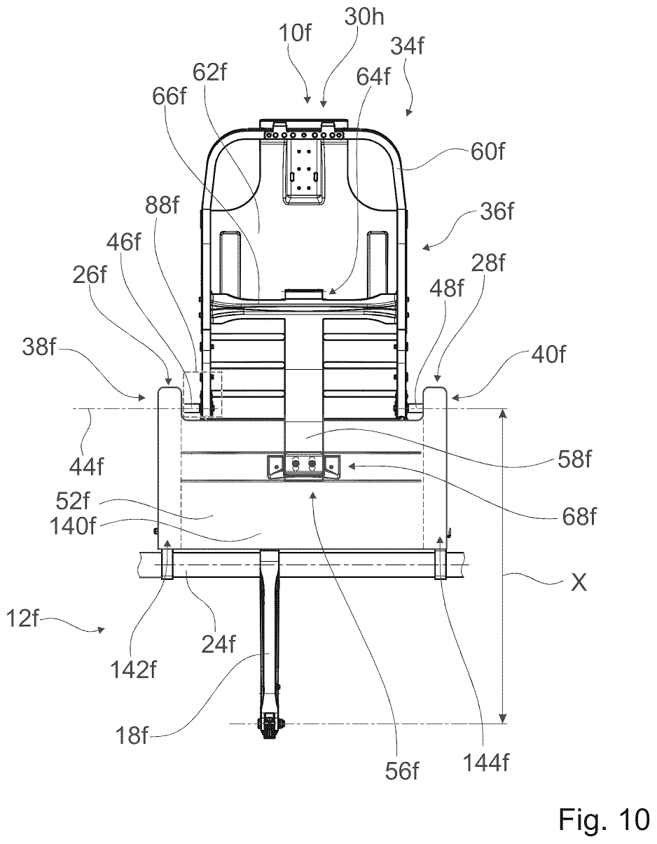

FIG. 10 shows a sixth exemplary embodiment of a passenger seat device according to the invention. The passenger seat device is part of a partially illustrated passenger seat 10f. The passenger seat device has a mounting unit 12f. The passenger seat 10f can be mounted on the cabin floor of the aircraft cabin by means of the mounting unit 12f. The mounting unit 12f has two transverse beams 24f. The passenger seat device has two seat structure elements 26f, 28f. The two seat structure elements 26f, 28f are in each case arranged on one side of a seat region 30f of the passenger seat device. The two seat structure elements 26f, 28f are in each case arranged laterally with respect to a seat region 30f which the passenger seat 10f forms. The pivotable backrest element 36f is pivotably attached to the seat structure elements 26f, 28f. The seat structure elements 26f, 28f each have a bearing point 38f, 40f for supporting the pivotable backrest element 36f.

The passenger seat device comprises a seat bottom 32f. The seat bottom 32f has a load-bearing main body. The seat bottom 32f furthermore has an upholstery element which is attached to the main body. The seat bottom 32f is attached to the mounting unit 12f. The passenger seat device comprises a backrest 34f. The backrest 34f is arranged pivotably with respect to the mounting unit 12f. The backrest 34f is attached to the seat structure elements 26f, 28f. The backrest 34f is embodied as a backrest with a high backrest pivot point. The backrest 34f has a lower backrest element 52f. The lower backrest element 52f forms a lower region of the backrest 34f. The lower backrest element 52f forms the backrest contact surface in the lower region of the backrest 34f. The lower backrest element 52f is connected rigidly to the mounting unit 12f. The backrest 34f is configured to be pivoted between an upright sitting position and a comfort position. The backrest 34f has a pivotable backrest element 36f. The pivotable backrest element 36f has a backrest frame 60f. The pivotable backrest element 36f has a shell element 62f. The pivotable backrest element 36f is embodied substantially identically to the first exemplary embodiment and is therefore not intended to be described in detail here.

In contrast to the preceding exemplary embodiments, the seat structure elements 26f, 28f are not embodied as seat dividers. The passenger seat device has a seat shell element 140f. The seat shell element 140f forms the lower backrest element 52f and the main body of a seat bottom 32f in one piece. The seat shell element 140f forms the main body of the seat bottom 32f in a lower, front region. In a rear region, the seat shell element 140f forms the lower backrest element 52f. The seat shell element 140f is formed from a fiber-reinforced plastic. The seat shell element 140f is preferably formed from a CFRP or a GRP. In principle, it is also conceivable for the seat shell element 140f to be formed from another suitable fiber-reinforced plastic. The seat shell element 140f is embodied in a substantially L-shaped manner in a side view. In contrast to the preceding exemplary embodiments, the seat structure elements 26f, 28f are embodied in one piece with the seat shell element 140f. The seat structure elements 26f, 28f are at least partially formed by the lower backrest element 52f and the main body of the seat bottom 32f. The seat shell element 140f has side regions 142f, 144f. As viewed in the transverse direction, the side regions 142f, 144f in each case form a lateral end of the seat shell element 140f. The seat structure elements 26f, 28f are embodied in the side regions 142f, 144f of the seat shell element 140f. The side regions 142f, 144f of the seat shell element 140f in each case form one of the seat structure elements 26f, 28f. Preferably, the seat shell element 140f has in each case at least one reinforcing element in its side regions 142f, 144f in order to form the seat structure elements 26f, 28f. The reinforcing elements can be embodied, for example, as inserts which are inserted into the side regions 142f, 144f of the seat shell element 140f. The reinforcing elements embodied as inserts could be embodied, for example, from a metal, such as an aluminum or a magnesium. In principle, it would also be conceivable for the reinforcing elements to be formed by local reinforcements from a CFRP or GRP.

The seat shell element 140f extends in its side regions 142f, 144f, in which it forms the seat structure elements 26f, 28f, as far as an upper edge of the lower backrest element 52f which it forms. The seat shell element 140f extends in its side regions 142f, 144f, in which it forms the seat structure elements 26f, 28f, as far as an armrest height X. The seat shell element 140f forms in its side regions 142f, 144f in each case in the upper end regions the bearing points 38f, 40f of the seat structure elements 26f, 28f. The seat shell element 140f forms in the upper end regions of its side regions 142f, 144f in each case the bearing points 38f, 40f of the seat structure elements 26f, 28f, via which the pivotable backrest element 36f is pivotably supported. The pivotable backrest element 36f is directly pivotably connected to the seat shell element 140f via the bearing points 38f, 40f.

The passenger seat device has a bearing device 42f. The bearing device 42f is configured to support the pivotable backrest element 36f pivotably between the upright sitting position and the comfort position. The bearing device 42f forms the axis of rotation 44f. The bearing device 42f has two bearing bolts 46f, 48f. The bearing bolts 46f, 48f are in each case connected to one of the bearing points 38f, 40f of the seat structure elements 26f, 28f embodied by the seat shell element 140f. The bearing bolts 46f, 48f are fixedly connected to the seat shell element 140f. The pivotable backrest element 36f is directly pivotably attached to the seat shell element 140f via the bearing bolts 46f, 48f.

The seat shell element 140f is embodied in a wider manner than the pivotable backrest element 36f. The seat shell element 140f engages with its upper ends of the side regions 142f, 144f, in which the bearing points 38f, 40f are arranged, around the pivotable backrest element 36, in particular the backrest frame 60f thereof, at its lower end. The bearing bolts 46f, 48f each extend inwards from the side regions 142f, 144f of the seat shell element 140f in the direction of the backrest frame 60f of the pivotable backrest element 36f. The pivotable backrest element 36f is pivotably attached to the bearing bolts 46f, 48f.

The passenger seat device has a restoring module 56f. The restoring module 56f is configured to restore the backrest 34f from the comfort position into an upright sitting position. The restoring module 56f is configured to restore the pivotable backrest element 36f. The restoring module 56f is configured to restore the backrest 34f, in particular to restore the pivotable backrest element 36f, in order to provide a restoring force. The restoring module 56f has a leaf spring element 58f for providing a restoring force. The restoring module 56f can preferably be embodied as in one of the preceding exemplary embodiments. By way of example, the restoring module 56f is embodied substantially identically to the first exemplary embodiment.

The leaf spring element 58f is functionally arranged between the seat shell element 140f and the pivotable backrest element 36f. The leaf spring element 58f is attached by way of its first, lower end to the seat shell element 140f, in particular to the lower backrest element 52f embodied by the seat shell element 140f. For attaching the leaf spring element 58f to the seat shell element 140f, the restoring module 56f has a fastening unit 68f. The leaf spring element 58f is movably attached to the seat shell element 140f via the fastening unit 68f. For attaching the leaf spring element 58f to the pivotable backrest element 36f, the restoring module 56f has a fastening unit 64f. The pivotable backrest element 36f has a transverse beam 66f. The leaf spring element 58f is attached directly to the transverse beam 66f via the fastening unit 64f.

The restoring module 56f has a locking unit 88f. The locking unit 88f is configured to lock or unlock the restoring module 56f. The locking unit 88f is functionally preferably arranged between the pivotable backrest element 36f, in particular the backrest frame 60f, and the seat shell element 140f. The locking unit 88f is arranged above a knee region 50f of the backrest 34f. The locking unit 88f is preferably arranged in a region above the bearing points 38f, 40f of the seat structure elements 26f, 28f formed by the seat shell element 140f. The locking unit 88f is preferably arranged substantially, that is to say for the most part, above the armrest height X.

1. A passenger seat device having a mounting unit which is configured for mounting on a cabin floor, having a backrest, and having a bearing device which is configured for supporting the backrest so as to be pivotable relative to the mounting unit between an upright sitting position and a comfort position, wherein the backrest comprises a pivotable backrest element, further comprising at least one restoring module which is configured at least for providing a restoring force for restoring the backrest from the comfort position into the upright sitting position, and for this purpose comprises at least one leaf spring element.

2. The passenger seat device according to claim 1, wherein the pivotable backrest element is pivotably connected to the mounting unit via the bearing device, wherein the leaf spring element is functionally arranged between the pivotable backrest element and the mounting unit.

3. The passenger seat device according to claim 1, wherein the leaf spring element is at least partially integrated into the pivotable backrest element.

4. The passenger seat device according to claim 3, wherein the leaf spring element is at least partially formed in one piece with the pivotable backrest element.

5. The passenger seat device according to claim 1, wherein at least in a lower region of the pivotable backrest element elastic ribs are arranged which each extend laterally outwards from a central region and which are configured for being deflected in a spring-elastic manner.

6. The passenger seat device according to claim 5, wherein the pivotable backrest element comprises a shell element which substantially forms in one piece the vertically continuous central region and the laterally outwardly extending ribs in a lower region.

7. The passenger seat device according to claim 6, wherein the continuous central region of the shell element has a receiving region for the leaf spring element or at least partially forms the leaf spring element.

8. The passenger seat device according to claim 1, wherein the backrest comprises a lower, rigid backrest element wherein the leaf spring element is functionally arranged between the lower backrest element and the pivotable backrest element.

9. The passenger seat device according to claim 8, wherein the leaf spring element is at least partially formed on one piece with the lower backrest element for providing a restoring force.

10. The passenger seat device according to claim 8, wherein the bearing device forms an axis of rotation via which the pivotable backrest element is pivotably supported relative to the lower backrest element, wherein the axis of rotation is arranged above a knee region of the backrest.

11. The passenger seat device according to claim 1, wherein the pivotable backrest element is supported on the mounting unit in a lower region.
